(19) United States
(12) Patent Application Publication
(10) Pub. No.: US 2008/0075398 A1
(43) Pub. Date: Mar. 27, 2008

(54) FLUID DYNAMIC BEARING DEVICE AND STORAGE DISK DRIVING DEVICE USING THE SAME

(75) Inventors: Akihiro KIMURA, Kyoto (JP); Kunio SAKURADA, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: Nidec Corporation, Minami-ku (JP)

(21) Appl. No.: 11/859,988

(22) Filed: Sep. 24, 2007

(30) Foreign Application Priority Data
Sep. 27, 2006 (JP) 2006-261756

(51) Int. Cl. F16C 32/06; G11B 17/00

(52) U.S. Cl. 384/107; 360/69; 360/97.01

(57) ABSTRACT

A fluid dynamic bearing device includes a shaft and a sleeve, with the shaft or the sleeve having a greater hardness being smoothed to have about 0.02 μm or less of the arithmetical average of the surface roughness. The hardness of the shaft or the sleeve having a greater hardness is a Vickers hardness of about 100 Hv or greater at a portion that is arranged to come into contact with the other of the shaft or the sleeve. Further, the hardness of the other of the shaft or the sleeve is a Vickers hardness of about 600 HV or smaller at a portion arranged to come into contact with the shaft or the sleeve having a greater hardness. A clearance of a radial gap defined between the shaft and the sleeve S is about 1.3 μm to about 2.5 μm. Other gaps defining the fluid dynamic bearing portion are configured such that the rotor hub (or the thrust plate) and the sleeve do not come into contact with each other at a thrust dynamic bearing portion when the shaft is slanted as much as possible relative to the sleeve in a state that the rotor is lifted to a rated flying height.

### BACKGROUND OF THE INVENTION

1. Field of the Invention

The present invention generally relates to a fluid dynamic bearing device and a storage disk driving device including the same, and particularly relates to structure preventing a fluid dynamic bearing from being worn and generating noise.

2. Description of the Related Art

A fluid dynamic bearing device using a fluid dynamic pressure is used for a bearing mechanism of a spindle motor installed in a data storage disk drive (e.g., a hard disk drive). In general, the fluid dynamic bearing device includes a shaft and/or a sleeve having dynamic pressure generating grooves arrayed in a predetermined shape (e.g., a herringbone shape and a spiral shape). When a rotor rotates about a center axis, high fluid dynamic pressure is generated by the groove array in the lubricating oil retained between the shaft and the sleeve, making it possible to support the shaft relative to the sleeve without coming into contact with each other. The fluid dynamic bearing device generally includes a radial bearing portion defined with radial dynamic pressure generating grooves arranged in a radially outer surface of the shaft and/or a radially inner surface of the sleeve, generating dynamic pressure supporting load in the radial direction. Further, the fluid dynamic bearing device generally includes a thrust bearing portion defined with thrust dynamic pressure generating grooves arranged in a thrust surface of the shaft, a rotor hub, and/or the sleeve, generating dynamic pressure supporting load in the axial direction.

### SUMMARY OF THE INVENTION

A fluid dynamic bearing device according to a preferred embodiment of the present invention has a novel structure to reduce an adverse effect caused by the shock or the vibration applied thereto.

A fluid dynamic bearing device is conventionally used for a spindle motor to spin a data storage disk of the storage disk driving device, and contributes to reduce the non-repeatable run-out of the spindle motor. It should be noted, however, the performance of conventional devices is deduced from premises that the device adapting the spindle motor is arranged in and in the static situation during the operation of the device.

In preferred embodiments of the present invention, the inventors take the situation in which the device can be in motion into account and invent a novel fluid dynamic bearing device having a structure reducing the noise generated by the fluid dynamic bearing device when the device adapting the conventional fluid dynamic bearing device is in motion during the operation thereof.

In a preferred embodiment of the present invention, dimensions of components defining the fluid dynamic bearing device are configured such that the rotational portion (e.g., the rotor hub) and the stationary portion (e.g., the sleeve) do not come into contact to each other at a thrust dynamic bearing portion when the shaft is slanted as much as possible relative to the sleeve. Specifically, when the shaft comes into contact with an axial upper end portion of the radially inner surface of the sleeve and an axial lower portion of the radially inner surface of the sleeve, the thrust plate and the sleeve do not come into contact with each other, wherein a line connecting an axial end portion and the other axial end portion passes the center axis.

As long as the device adapting the conventional fluid dynamic bearing device is arranged in the static situation during the operation thereof, the conventional fluid dynamic bearing device stably supports the rotational portion. However, when the device is in motion during the operation thereof, abnormal forces maybe applied to the fluid dynamic bearing device, and the rotor hub and/or the thrust plate may come into contact with the sleeve. Notably, the inventors determined that the undesirable noise is not generated when the shaft and the sleeve come into contact with each other, but the undesirable noise is generated when the rotor hub and/or the thrust plate comes into contact with the sleeve. Thus, in the preferred embodiments of the present invention, a clearance in the radial dynamic bearing portion is reduced and a clearance in the thrust dynamic bearing portion is increased. Through this configuration, it is possible to prevent the thrust plate and/or the rotor hub from coming into contact with the sleeve, thus preventing the generation of the undesirable noise.

In the preferred embodiments of the present invention, the hardness of the shaft and the sleeve may be preferably configured, and the surface of the shaft or the sleeve having greater hardness, coming into contact with the other, may be smoothed to have about 0.02 μm or less of the arithmetical average of the surface roughness.

In case that there is roughness on a surface of the shaft or the sleeve having a greater hardness, the other is worn when they come into contact with each other. Eventually the shaft slanted greatly and thus, the thrust plate and/or the rotor hub comes into contact with the sleeve. In the preferred embodiments of the present invention, however, the shaft or the sleeve having greater hardness has a smoothed surface. With this configuration, it is possible to prevent the shaft or the sleeve from being worn.

The fluid dynamic bearing device according to a preferred embodiment of the present invention is preferably used for a data storage disk drive such as a hard disk drive. For example, the hard disk drive adapting the fluid dynamic bearing device according to a preferred embodiment of the present invention does not generate undesirable noise when it is in motion during the operation. Particularly, the fluid dynamic bearing device is preferably used for a hard disk drive having 2.5 inch or less magnetic disks therein, generally used for a portable device.

Even when the sleeve and the shaft are made of different materials, the surface of the shaft or the sleeve having a greater hardness can be smoothed to have about 0.02 μm or less of the arithmetical average of the surface roughness to prevent the surface of the shaft or the sleeve having a greater hardness from wearing the other, thereby improving the durability and the bearing life.

In a preferred embodiment of the present invention, the hardness of the shaft or the sleeve having a greater hardness preferably is a Vickers hardness of about 100 Hv or greater at a portion that contacts with the other. Further, the hardness of the other preferably is a Vickers hardness of about 600 HV or smaller at a portion to come into contact with the shaft or the sleeve having a greater hardness. With this configuration, it is possible to effectively prevent the shaft or the sleeve having a greater hardness from wearing the other.

According to the preferred embodiments of the present invention, the fluid dynamic bearing device includes a thrust plate and/or a rotor hub attached to an axial end portion(s) of the shaft. In the state that the rotor hub and/or the thrust plate is lifted to a rated flying height, the rotor hub and/or the thrust plate does not come into contact with the sleeve when the shaft is slanted until the shaft comes into contact with both axial ends of a radially inner surface of the sleeve defining a through hole in which the shaft is inserted. Since the fluid dynamic device according to the preferred embodiments of the present invention does not generate undesirable noise even if the fluid dynamic bearing device or the apparatus in which it is provided is moved during the operation thereof, the fluid dynamic bearing device according to the preferred embodiments of the present invention can be preferably used for a portable device such as a portable digital music player.

According to the preferred embodiments of the present invention, the clearance of the axial gap defining the thrust dynamic bearing portion gradually increases toward a radially outer direction. It is therefore possible to further prevent the thrust plate and/or the rotor hub from coming into contact with the sleeve.

In the preferred embodiments of the present invention, the clearance of the radial gap defining the radial dynamic bearing portion is in the range of about 1.3 μm to about 2.5 μm.

The fluid dynamic bearing device according to the preferred embodiments of the present invention is preferably used for a hard disk drive with 2.5 inch or smaller disk(s). With smaller disk(s), a load applied to the fluid dynamic bearing portion is reduced, further preventing the shaft and/or the sleeve having greater hardness from wearing the other. Thus, it is possible to provide a durable hard disk drive which does not generate undesirable noise when it is moved during the operation thereof.

Other features, elements, steps, processes, characteristics and advantages of the present invention will become more apparent from the following detailed description of preferred embodiments of the present invention with reference to the attached drawings.

### BRIEF DESCRIPTION OF THE DRAWINGS

FIG. 1 is a cross sectional view illustrating a fluid dynamic bearing device according to a first preferred embodiment of the present invention.

FIG. 2 is a plan view of a sleeve illustrated in FIG. 1.

FIG. 3 is a cross sectional view illustrating the fluid dynamic bearing device according to a variant of the first preferred embodiment of the present invention.

FIG. 4 is a plan view of a sleeve illustrated in FIG. 3.

FIG. 5 is a view illustrating a positional relationship of a rotor hub and a sleeve housing.

FIG. 6 is a graph illustrating a relationship between the arithmetical average of the surface roughness and a wearing amount.

FIG. 7 is a cross sectional view illustrating a fluid dynamic bearing device according to a second preferred embodiment of the present invention.

FIG. 8 is a cross sectional view illustrating the fluid dynamic bearing device according to the second preferred embodiment in a state the shaft is slanted as much as possible.

FIG. 9 is a cross sectional view illustrating a hard disk drive.

FIG. 10 is a perspective view illustrating a portable device.

### DETAIL DESCRIPTION OF THE PREFERRED EMBODIMENTS

### First Preferred Embodiment

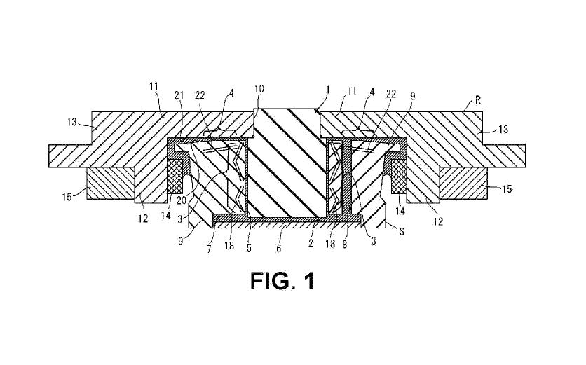

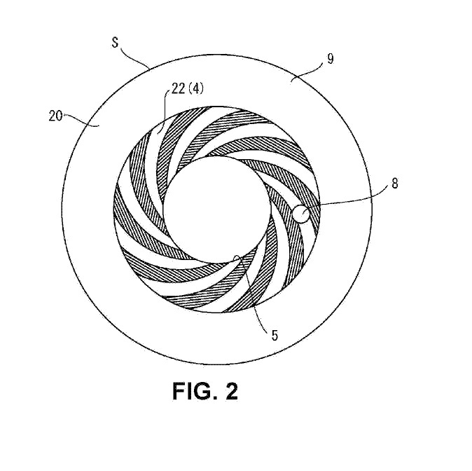

With reference to attached drawings, preferred embodiments of the present invention will be described in detail. FIG. 1 is a cross sectional view illustrating a fluid dynamic bearing device according to a first preferred embodiment of the present invention. FIG. 2 is a plan view of a sleeve S.

As illustrated in FIG. 1, the fluid dynamic bearing device includes the sleeve S and a rotor hub R having a greater diameter than that of the sleeve S. The rotor hub R is attached to a shaft 1 supported by the sleeve S in a rotatable manner. There is provided a gap between the sleeve S and the rotor hub R, and the gap is filled with lubricating oil 2. There is provided a radial bearing portion 3 and a thrust bearing portion 4, and with these bearing portions, the rotor hub R is supported in a manner such that the rotor hub 3 rotates without coming into contact with the sleeve S. For the sake of convenience, the upward and downward orientations in FIG. 1 are described as “upper/lower,” “top/bottom,” “along the axial direction,” etc., but that is not intended to limit the orientation of the fluid dynamic bearing device, a motor, and a storage disk drive according to the preferred embodiments of the present invention in an actually installed situation.

The sleeve S has a hollow cylindrical shape having a radially inner surface defining a bearing hole 5 axially penetrating the sleeve, and the shaft 1 is inserted into the bearing hole 5. An opening arranged axially below the bearing hole 5 is sealed with a sealing cap 6, defining with the sleeve S a substantially cup shape having an axially upper opening. There is provided an axially lower portion of the sleeve S at which a diameter of the sleeve S radially outwardly expands, defining an oil pool portion 7 reserving the lubricating oil 2. The sleeve S further includes a circulation hole extending along the center axis and connecting the oil pool portion 7 and an axially upper end surface of the sleeve 7 to circulate the lubricating oil 2.

The sleeve S also includes a flange portion 9 radially outwardly extending at an axially upper end portion of the sleeve S. An axially upper portion of the radially outer surface of the sleeve S is constricted gradually toward the axially lower direction and radially opposes to the radially inner surface of the rotor hub R via a gap defined therebetween. With this configuration, the gap functions as a capillary seal portion preventing the outflow of the lubricating oil 2.

The rotor hub R includes a discoid portion 11 (a thrust plate) having a center through hole 10 in which an axially upper end portion of the shaft 1 is inserted, a cylindrical portion 12 axially downwardly extending from a the discoid portion, and a rotor flange portion 13 radially outwardly extending from a radially outer surface of the rotor hub R

The shaft 1 has a substantially column shape and the axially upper end portion of the shaft 1 is inserted into the center through hole 10 and is attached to the discoid portion 11 such that center axes of the rotor hub R and the shaft 1 are substantially aligned.

The shaft 1 is inserted into the sleeve S and the rotor hub R is supported in a rotatable manner. A retaining member 14 having a substantially ring shape is attached to the radially inner surface of the cylindrical portion 12. When a force to remove the rotor hub R from the sleeve S is applied in the axially upper direction, the retaining member 14 engages with the flange portion 9 of the sleeve S and prevents the rotor hub R from being removed.

In the present preferred embodiment of the present invention, the sleeve S is preferably made of ferritic stainless steel for the sake of facilitating the cutting process in the manufacture thereof, and the shaft 1 is preferably made of martensitic stainless steel having greater hardness than the ferritic stainless steel. It should be noted that the sleeve S may be defined with a plurality of members, e.g., the sleeve S may include a sleeve body made of porous sintered material essentially composed of copper and a sleeve housing made of phosphor bronze, having a substantially cup shape in which the sleeve body is attached.

There are provided gaps in between the sleeve S and the rotor hub R, in between the sleeve S and the shaft 1, and the gaps are filled with the lubricating oil 2 (e.g., ester oil). In particular, gaps are provided in the fluid dynamic bearing device, in between the radially inner surface of the cylindrical portion 12 of the rotor hub R, and the radially outer surface of the sleeve S, in between the axially lower surface of the discoid portion 11 of the rotor hub R, and the axially upper end surface of the sleeve S; in between the radially inner surface of the sleeve S, and the radially outer surface of the shaft 1; and in between the axially lower end surface of the shaft 1, and the axially upper surface of the sealing cap 6. Those gaps are filled with the lubricating oil 2 without interruption.

An annular rotor magnet 15 is attached to an axially lower surface of the flange portion 13. The rotor magnet 15 is magnetized in the circumferential direction such that S and N poles are alternately arranged. An armature (not illustrated in drawings) is arranged radially outside of the rotor magnet 15 such that the armature radially opposes the rotor magnet 15 via a gap defined therebetween. The armature interacts with the rotor magnet 15 upon energizing the armature, and the rotor hub R rotates about the center axis.

The sleeve S includes the radial bearing portion 3 and the thrust bearing portion 4 to support the rotor hub R in a non-contact manner when the rotor hub R rotates.

The radial bearing portion 3 is defined with a portion of the radially inner surface of the sleeve S, a portion of the radially outer surface of the shaft 1 radially opposing to the radially inner surface of the sleeve S, and the lubricating oil 2 filling the gap defined between the sleeve S and the e shaft 1. In addition, a plurality of dynamic pressure generating grooves (e.g., grooves arrayed in a herringbone shape, that is, a herringbone groove array 18) is arranged in the radially inner surface of the sleeve S. The dynamic pressure generating grooves generate the hydrodynamic pressure in the lubricating oil 2 by directing the lubricating oil to flow toward a predetermined portion along the rotational direction of the rotor hub R.

The thrust bearing portion 4 is defined with the axially upper end surface of the sleeve S, the axially lower surface of the discoid portion 11 of the rotor hub R, and the lubricating oil 2 filling the gap defined between the sleeve 4 and the discoid portion 11. In particular, as illustrated in FIGS. 1 and 2, the sleeve S includes a sleeve thrust surface 20 radially outwardly extending from the upper end of the radially inner surface of the sleeve S. In the present preferred embodiment of the present invention, the sleeve thrust surface 20 is perpendicular or substantially perpendicular to the shaft 1 and radially extends from the upper end of the radially inner surface of the sleeve S to the radially middle portion of the axially upper end surface of the sleeve S. In addition, the rotor hub R includes a rotor thrust surface 21 axially opposing the sleeve thrust surface 20, perpendicular or substantially perpendicular to the shaft 1, arranged in the axially lower surface of the discoid portion 21. As described above, the thrust bearing portion 4 is defined by the sleeve thrust surface 20, the rotor thrust surface 21, and the lubricating oil 2 filling the gap defined therebetween. In the present preferred embodiment of the present invention, the sleeve thrust surface 20 and the rotor thrust surface 21 are substantially parallel to each other. As illustrated in FIG. 2, there are provided a plurality of dynamic pressure generating grooves arrayed in the spiral shape (i.e., a spiral groove array 22) in the sleeve thrust surface 20. The spiral groove array 22 generates the flow of the lubricating oil 2 toward the radially inner direction in the thrust bearing portion 4 when the rotor hub R rotates.

As illustrated in FIG. 1, a radially outer portion of the axially upper surface of the sleeve S is slanted such that the axial clearance of the gap defined between the axially lower surface of the discoid portion 11 and the axially upper surface of the sleeve S gradually increases toward the radially outside of the sleeve S.

When the rotor hub R rotates upon energizing the armature, the shaft 1 is supported in a manner without coming into contact with the radially inner surface of the sleeve S due to the dynamic pressure generated by the radial bearing portion, and the rotor hub R is supported in a manner axially lifted and without coming into contact with the sleeve S due to the dynamic pressure generated by the thrust bearing portion.

Recently, a motor incorporating the fluid dynamic bearing device has been installed into the portable devices, such as portable digital music players. When the devices are moved during its operation, the abnormal force is applied to the fluid dynamic bearing, and the rotor hub R and the sleeve S may come in contact with each other while the rotor hub R rotates.

In a storage disk drive, a data storage disk is mounted on the rotor hub and rotates therewith in a high speed, thus the rotor portion including the rotor hub and the data storage disk stores high angular momentum. Thus, when the storage disk drive is moved during the operation thereof, the rotor portion cannot follow the motion of the storage disk drive, and the rotor hub and/or the shaft comes into contact with the sleeve. The contact of the rotor hub and/or the shaft, and the sleeve during the rotor rotates generates an undesirable noise like the sound of frogs croaking. It is extremely undesirable that such undesirable noise is generated while the portable audio player is operated.

The inventors of the present invention discovered that the contact between the rotor hub and/or the thrust plate, and the sleeve at the thrust bearing portion generates the undesirable noise through the extensive research. Furthermore, the inventors of the present invention discovered that the contact in the thrust bearing portion mainly contributes to the generation of the undesirable noise. Generally, the thrust dynamic bearing portion is arranged radially outside of the radial dynamic bearing portion, and thus has a higher circumferential speed. When an abnormal force is applied to the fluid dynamic bearing device and the rotor portion is slanted relative to the sleeve, the rotor portion may come into contact with the sleeve at the radially outermost portion thereof having the highest circumferential speed. Generally, a thrust bearing surface arranged in the rotor hub and/or the thrust plate comes into contact with the sleeve, and due to their discoid shape, the undesirable noise is generated.

In the present preferred embodiment of the present invention, the fluid dynamic bearing device has a configuration in which the rotor hub R does not come into contact with the sleeve S when the rotor hub R is slanted as much as possible. Particularly, in the fluid dynamic bearing device according to the present preferred embodiment of the present invention, the axial clearance of the gap defining the thrust bearing portion is configured such that the rotor hub R does not come into contact with the sleeve S when the shaft 1 is slanted until the axially upper and lower portions of the shaft 1 come into contact with axially upper and lower ends of a radially inner surface of the sleeve S defining the bearing hole in which the shaft 1 is inserted, in the state that the rotor hub R is lifted to a rated flying height. In other words, when the shaft comes into contact with an axially upper end portion of the radially inner surface of the sleeve and an axially lower portion of the radially inner surface of the sleeve, the thrust plate and the sleeve do not come into contact with each other, wherein a line connecting one axial end portion and the other axial end portion passes the center axis. In order to realize the configuration described above, it is preferable, but not limited, that the thrust bearing portion 4 is arranged near the upper opening of the cup-shaped sleeve S.

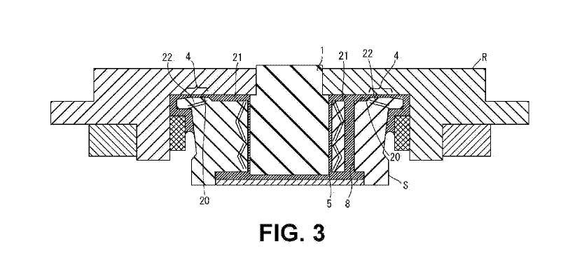

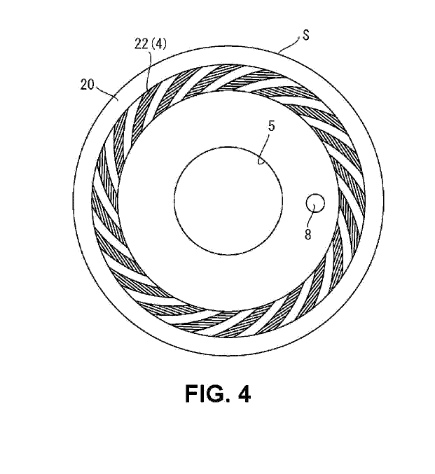

Referring to FIGS. 3 and 4, conventionally, the thrust bearing portion 4 is defined by the radially outer portion in the axially upper surface of the sleeve S (i.e., a sleeve thrust bearing surface), the portion of the axially lower surface of the rotor hub R axially opposing thereto via a gap (i.e., a rotor thrust bearing surface), and the lubricating oil 2 filling the gap. In addition, to effectively generate the dynamic pressure in the lubricating oil, the axial clearance of the gap defining the thrust bearing portion is configured to be smaller than that of other portion between the sleeve S and the rotor hub R axially opposing to each other. Thus, in the conventional fluid dynamic bearing device, the sleeve thrust bearing surface and the rotor thrust bearing surface easily come into contact with each other due to the slight inclination of the shaft.

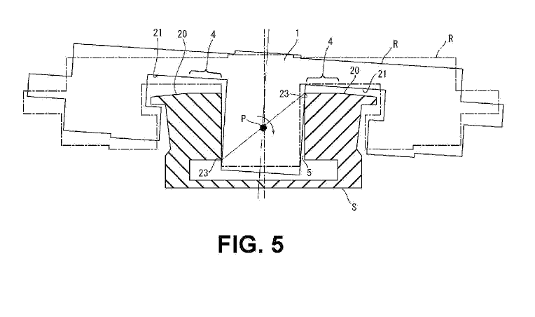

In the present preferred embodiment of the present invention, the fluid dynamic bearing device has an outer diameter of the thrust bearing portion 4, an axial length of the shaft 1, and a radial clearance of the gap defined between the shaft 1 and the sleeve S, each of which is preferably configured. As illustrated in FIG. 5, in the fluid dynamic bearing device according to the present preferred embodiment of the present invention, the rotor hub R does not come into contact with the sleeve S when the shaft 1 is slanted until the axially upper and lower portions of the shaft 1 respectively come into contact with axially upper and lower ends of a radially inner surface of the sleeve S defining the bearing hole in which the shaft 1 is inserted, in the state that the rotor hub R is lifted to the rated flying height.

In the present preferred embodiment of the present invention, as illustrated in FIG. 1, a radially outer portion of the axially upper surface of the sleeve S is slanted such that the axial clearance of the gap defined between the axially lower surface of the discoid portion 11 and the axially upper surface of the sleeve S gradually increases toward the radially outside of the sleeve S. With this configuration, it is possible to stably prevent the rotor hub R and the sleeve S from coming into contact with each other. The rated flying height in the present preferred embodiment of the present invention refers to a height to which the rotor hub R with the data storage disk arranged thereon is to be lifted when the rotor hub R stably rotates in a predetermined rotational speed. In FIG. 5, the rotor hub R lifted to the predetermined flying height is illustrated by chain lines. In other words, the state that the rotor hub R is lifted in the rated flying height can be understood that the predetermined axial gap is defined between the rotor hub R and the sleeve S during the rotation of the rotor hub R.

Through the configuration illustrated in FIG. 5, the sleeve thrust bearing surface 20 and the rotor thrust bearing surface 21 do not come into contact with each other, when the fluid dynamic bearing device is moved during the operation thereof and the abnormal force slanting the shaft 1 in the radial direction is applied to the rotor hub R.

According to the present preferred embodiment of the present invention, portions of the shaft 1 and the sleeve S that come into contact with each other may wear out after the prolonged period of operation of the fluid dynamic bearing device. It may result in enlarging the radial clearance of the gap between the shaft 1 and the sleeve S. With the enlarged radial clearance, the shaft 1 may be slanted greatly and the sleeve thrust bearing surface 20 and the rotor thrust bearing surface 21 come into contact with each other, generating undesired noise. In the present preferred embodiment of the present invention, the following configuration is adapted to the fluid dynamic bearing device to prevent wearing out of the shaft 1 and the sleeve S, and the generation of the undesired noise for a prolonged period.

In the present preferred embodiment of the present invention, the radial clearance of the gap defined between the shaft 1 and the sleeve S is preferably smaller than that of the general fluid dynamic bearing device (about 1.3 μm to about 2.5 μm in the present preferred embodiment of the present invention) to reduce the inclination of the shaft 1 relative to the center axis. When the radial clearance of the gap is smaller than about 1.3 μm, the friction resistance between the shaft 1 and the sleeve S drastically increases.

With the reduced radial clearance of the gap, the risk of the shaft 1 and the sleeve S coming into contact with each other and wearing out increases. Thus, in the present preferred embodiment of the present invention, super-finishing is applied to the shaft 1 or the sleeve S having greater hardness to have an extremely smoothed surface. The super-finishing is a surface-finishing process which produces a very fine, mirror-smooth finish for example. With this configuration, it is possible to prevent the shaft 1 or the sleeve S having the greater hardness from wearing the other. By applying the super-finishing process to the shaft 1 or the sleeve S, it is possible to delay that the shaft 1 or the sleeve S having the greater hardness wears out the other. However, it is preferable that the fluid dynamic bearing adapts the reduced radial clearance of the gap and the super-finishing process.

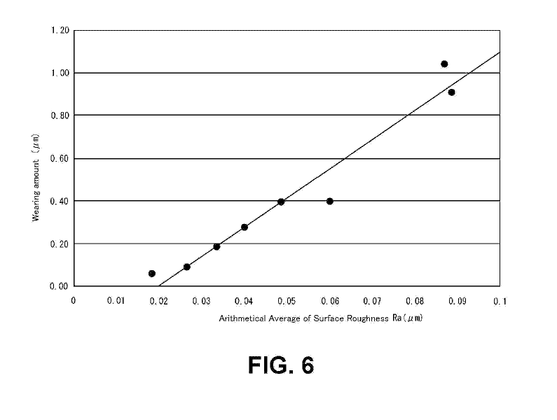

FIG. 6 is a graph illustrating a relationship between the arithmetical average of the surface roughness and a wearing amount. The wearing amount was measured in the fluid dynamic bearing device illustrated in FIG. 5 on which the 1.8 inch magnetic disk is arranged.

In the measurement, the fluid dynamic bearing device as follow was used. In the fluid dynamic bearing device, the shaft had about 3.3 mm axial length and about 2.5 mm diameter. The radial gap defined between the shaft and the sleeve was about 2.5 μm, and the rated flying height of the thrust bearing portion was about 10 μm. The shaft was made of stainless steel (SUS420J2 in accordance with JIS (Japanese Industrial Standards)). The surface of the shaft was smoothed by cutting and grinding. The arithmetical average of the surface roughness of the radially outer surface of the shaft is varied by changing the grinding configuration.

The sleeve was made of DHS-1 (registered mark), and the radially inner surface of the sleeve was processed with an appropriate surface finishing. The sleeve had Vickers hardness (VH) of about 290 (290 HV) at a portion to come into contact the shaft. The hardness of the shaft was about 700 HV at a portion to come into contact with the sleeve. The arithmetical average of the surface roughness was measured along the axial direction with the Surface Roughness Meter.

The fluid dynamic bearing was installed in a storage disk drive device, in which the 1.8 inch magnetic disk was mounted on the fluid dynamic bearing. Then, the storage disk drive was placed on a shaker table, which applied a rocking movement, rocking the storage disk drive back and force, centered on a pivot axis arranged in the shaker table and substantially perpendicularly across the rotational axis of the fluid dynamic bearing device. The angle of the rocking movement was approximately 90 degrees about the pivot axis, and frequency of the rocking movement was about 1.5 Hz. While the disk drive was operated, the one-minute rocking movement was applied thereto, and then, the fluid dynamic bearing device was taken out from the storage disk drive and the wearing amount was measured.

As illustrated in FIG. 6, there is a substantially clear correlation between the wearing amount and the arithmetical average surface roughness (Ra). Please note that the arithmetical average surface roughness (Ra) is defined in accordance with Japanese Industrial Standards (JIS). As the surface roughness (Ra) is reduced, the wearing amount is reduced as well. The wearing amount is linearly reduced as the surface roughness is reduced when the surface roughness is greater than about 3 μm. Thus, in the preferred embodiment of the present invention, the surface roughness of the sleeve is to be about 0.03 μm or less.

When the shaft has the hardness greater than that of the sleeve, the hardness of the shaft on the radially outer surface is preferably configured to be about 500 HV to about 750 HV, and the hardness of the sleeve on the radially inner surface is preferably configured to be about 150 HV to about 200 HV. It should be noted that the hardness of the shaft and the sleeve maybe variously modified. The hardness of the shaft is preferably greater than about 100 HV and exceeds the hardness of the sleeve, and the hardness of the sleeve is less than about 600 HV and smaller than the hardness of the shaft.

When the arithmetical average surface roughness of the shaft 1, having the hardness greater than that of the sleeve, is about 0.03 μm or less, it is possible to prevent the sleeve from being worn, even if the shaft and the sleeve are made of different material from each other. In general, the conventional shaft used for the conventional fluid dynamic bearing has about 0.06 μm surface roughness.

In the foregoing description of the preferred embodiments of the present invention, the shaft 1 comes into contact with the axially upper and lower ends of the radially inner surface of the sleeve S when the shaft 1 is slanted as much as possible. It should be noted that the shaft 1 may come into contact with other portions of the sleeve S upon slanting the shaft 1 as much as possible. Such portions may be varied based on the shape and the like configuration of the sleeve. Furthermore, the sleeve and the shaft do not necessarily satisfy the hardness and surface roughness described above across the entire section thereof. The sleeve and the shaft may include contacting portions coming into contact with each other, having the preferable hardness and the preferable surface roughness described above.

### Second Preferred Embodiment

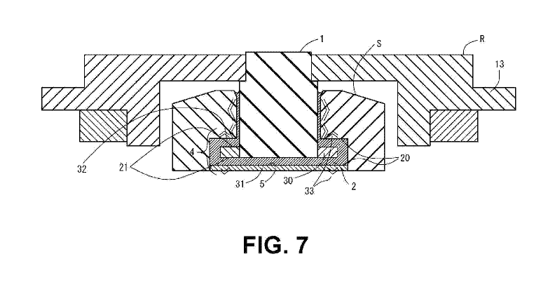

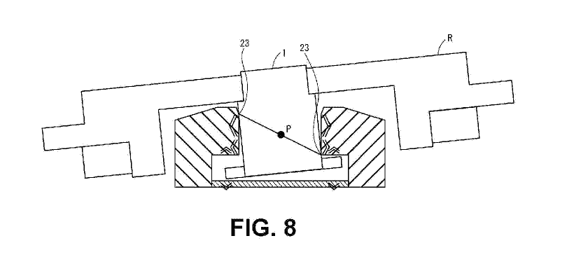

With reference to FIGS. 7 to 8, a second preferred embodiment of the present invention is described in detail. FIG. 7 is a cross sectional view illustrating a fluid dynamic bearing device according to the second preferred embodiment of the present invention. FIG. 8 is a cross sectional view illustrating the fluid dynamic bearing device according to the second preferred embodiment in a state the shaft is slanted as much as possible. The members having substantially the same functions as the counterparts of the first preferred embodiment are identified by the same reference numerals in FIGS. 7 and 8.

As illustrated in FIG. 7, a motor includes a shaft 1 and a thrust plate 30 attached to an axially lower end of the shaft 1. A sleeve S includes a bearing hole 5 in which the shaft 1 is inserted. An axially lower portion of the bearing hole 5 radially outwardly expanding such that the thrust plate 30 is housed in the bearing hole 5. Hereinafter, the portion of the bearing hole 5 radially outwardly expanding at the axially lower portion thereof is simply referred to as a step portion 32. An axially lower end of the bearing hole 5 is sealed with a counter plate 31. The bearing hole 5 is filled with lubricating oil 2.

There is provided a set of thrust bearing portions 4, one is arranged on the axially upper side of the thrust plate 30 (i.e., an upper thrust bearing portion) and the other is at the axially lower side thereof (i.e., a lower thrust bearing portion). In the following description, axially upper and lower surfaces of the thrust plate 20 are referred to as thrust plate bearing surfaces 21, and an axially upper surface of the counter plate 31 and an inner surface of the sleeve S radially inwardly extending to define the step portion 32 and axially opposing the thrust plate bearing surfaces 21, respectively, are referred to as sleeve thrust bearing surfaces 20. Those thrust bearing surfaces 20 and 21 include dynamic pressure generating grooves arrayed in the herringbone shape, respectively. In the present preferred embodiment of present invention, the upper thrust bearing portion and the lower thrust bearing portion generate the dynamic pressure in the lubricating oil directed in axially opposite directions from each other. The shaft 1 and the rotor R is lifted to the point where the dynamic pressures generated by the upper and lower thrust bearing portions are balanced. The fluid dynamic bearing device according to the present preferred embodiment of the present invention has a configuration in which the rotor hub R and the sleeve S, the thrust plate 30 and the sleeve S do not come into contact with each other when the shaft 1 is slanted until the axially upper and lower portions of the shaft 1 come into contact with axially upper and lower ends of a radially inner surface of the sleeve S defining the bearing hole in which the shaft 1 is inserted, in the state that the rotor hub R is lifted to a predetermined flying height, as illustrated in FIG. 8.

The configuration of the radial gap defined between the shaft 1 and the sleeve S, the hardness, the surface roughness and the like is as described in the description of the first preferred embodiment of the present invention. With this configuration, the generation of the undesirable noise is restricted.

### Third Preferred Embodiment

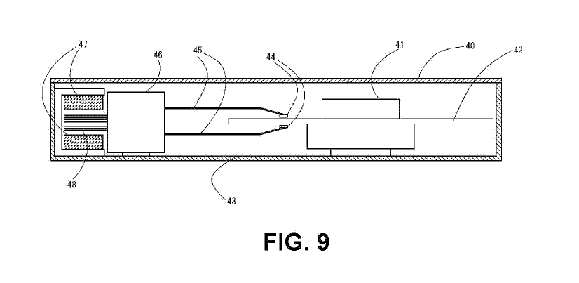

With reference to FIG. 9, a third preferred embodiment of the present invention will be described in detail. FIG. 9 is a cross sectional view illustrating a hard disk drive adapting the above-mentioned fluid dynamic bearing device.

As illustrated in FIG. 9, a spindle motor 41 using the fluid dynamic bearing device is arranged on a base 43, and a magnetic disk 42 is arranged on the spindle motor 41. The hard disk drive includes heads 44 that are brought adjacent to the magnetic disk 42 to read information from and write information onto the magnetic disks 42, arms 45 that support the heads 44, and a pivot 46 that is a center axis of the swivel movement of the head 44, and a voice coil motor having a coil 48 and a magnet 47 and moving the arms 45 about the pivot 46. Through the configuration of these components, the heads 44 access required positions on, in a state in which the heads 44 have been brought adjacent to, the spinning magnetic disk 42, to conduct the reading and/or writing of information onto the magnetic disk 42. In FIG. 9, a damper retaining the magnetic disk 42 on the spindle motor, wires connected to the heads 44, etc., are not illustrated.

By adapting the fluid dynamic bearing device according to the preferred embodiments of the present invention, generation of the undesirable noise of the hard disk drive is restricted when the hard disk drive is moved during the operation thereof. Furthermore, since the wearing out of the fluid dynamic bearing device is restricted, the hard disk drive according to the present preferred embodiment of the present invention may be reliably used for extended period.

It is preferable that the magnetic disk having 2.5 inch or smaller diameters is mounted on the spindle motor 41. With this configuration, it is possible to reduce the weight of the rotor portion having the rotor hub R and the magnetic disk 42, reducing the load to be applied to the shaft 1 and the sleeve S. Thus, it is possible to further restrict the wearing out of the fluid dynamic bearing device and the generation of the undesirable noise.

### Fourth Preferred Embodiment

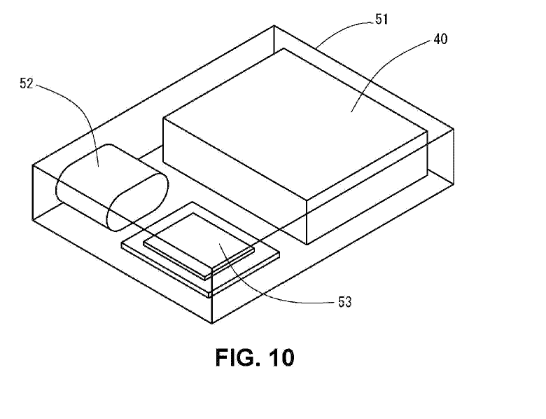

With reference to FIG. 10, a fourth preferred embodiment of the present invention will be described in detail. FIG. 10 is a perspective view illustrating a portable device according to the fourth preferred embodiment of the present invention. For convenience's sake in the description, a casing 51 is illustrated in a transparent manner, and wires, connectors, and the like are omitted. The portable device according to the present preferred embodiment of the present invention includes a hard disk drive 40, an integrated circuit 53 processing the signal from the hard disk drive 40, a battery 52 supplying electricity to the integrated circuit 53 and the hard disk drive 40. The integrated circuit 53 may be a decoder IC which decodes digital AV data such as MPEG1 Audio Layer 3 data, MPEG 2 data, and MPEG4 data. Alternatively, the integrated circuit 53 may be an interface circuit to use the hard disk drive 40 as an external disk drive for a personal computer.

According to the present preferred embodiment of the present invention, the generation of the undesirable noise can be prevented when the portable device is moved during the operation thereof.

While preferred embodiments of the present invention have been described in the foregoing, the present invention is not limited to those detailed above, in that various modifications are possible.

In the first and second preferred embodiments of the present invention, the shaft 1 preferably has a greater hardness than that of the sleeve S. Alternatively, the sleeve may have a greater hardness than that of the shaft, and the surface of the sleeve S to come into contact with the shaft 1 may be smoothed by super-finishing. The sleeve S can be attached to the rotor hub R. In this case, the shaft 1 is attached to the stator portion and is inserted into the bearing hole 5 arranged in the sleeve S attached to the rotor hub R.

The preferable hardness and the preferable surface roughness of the shaft and the sleeve described above are not limited to those described above, they can be variously modified. For example, surfaces of the shaft and the sleeve to come into contact with each other may be coated with the diamond-like-carbon, in which the hardness of the surfaces maybe about 2000 HV to about 3000 HV. Through the configuration, it is possible to provide a fluid dynamic bearing device which is reliable and has a prolonged bearing life.

Only selected preferred embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the preferred embodiments according to the present invention is provided for illustration only, and not for limiting the invention as defined by the appended claims and their equivalents.

What is claimed is:

1. A fluid dynamic bearing device comprising:
a shaft having a substantially column shape centered about a center axis;
a sleeve having a radially inner surface defining a bearing hole in which the shaft is inserted and radially opposing a radially outer surface of the shaft via a radial gap defined therebetween;
a thrust plate having a discoid shape coaxial with the shaft and attached to the shaft, and axially opposed to the sleeve via an axial gap defined therebetween; and
a lubricating oil filling the radial gap and the axial gap; wherein
the sleeve and the thrust plate are maintained in position without coming into contact with each other when the shaft comes into contact with the sleeve.

2. The fluid dynamic bearing device as set forth in claim 1, wherein the thrust plate and the sleeve are maintained in position without coming into contact with each other when the shaft comes into contact with a first axial end portion of the radially inner surface of the sleeve and a second axial end portion of the radially inner surface of the sleeve, and a line connecting the first and second axial end portions substantially passes the center axis.

3. The fluid dynamic bearing device as set forth in claim 1, wherein the sleeve includes a thrust bearing surface opposing the thrust plate and arranged on an axial end surface of the sleeve, a clearance of the axial gap defined between the sleeve and the thrust plate gradually expands in an outer radial direction radially outside of the thrust bearing surface.

4. The fluid dynamic bearing device as set forth in claim 1, wherein the shaft or the sleeve having a greater hardness has an arithmetical average surface roughness of about 0.02 μm or less at a portion arranged to come into contact with the other of the shaft or the sleeve.

5. The fluid dynamic bearing device as set forth in claim 4, wherein a clearance of the radial gap defined between the shaft and the sleeve is about 1.3 μm to about 2.5 μm.

6. The fluid dynamic bearing device as set forth in claim 1, wherein the shaft and the sleeve have a Vickers Hardness of about 2000 or greater at surfaces thereof arranged to come into contact with each other.

7. The fluid dynamic bearing device as set forth in claim 1, wherein a hardness of one of the shaft or the sleeve is a Vickers Hardness of about 100 or greater and is greater than a hardness of the other of the shaft or the sleeve.

8. The fluid dynamic bearing device as set forth in claim 1, wherein a hardness of one of the shaft or the sleeve is a Vickers Hardness of about 600 or smaller and is smaller than a hardness of the other of the shaft or the sleeve.

9. A storage disk drive comprising:
the fluid dynamic bearing device as set forth in claim 1;
a rotor hub supported by the fluid dynamic bearing device in a rotatable manner centered about the center axis;
a data storage disk having about 2.5 inch or less diameter and arranged on the rotor hub;
a base plate on which the fluid dynamic bearing device is arranged;
a driving mechanism which rotates the rotor hub and the data storage disk; and
a head which reads information from the data storage disk and/or writes information onto the data storage disk.

10. A portable electronic device comprising:
the storage disk drive as set forth in claim 9;
an integrated circuit processing information from the data storage disk;
a casing accommodating the data storage disk drive and the integrated circuit.

11. A fluid dynamic bearing device comprising:
a static portion; and
a rotor portion supported by a thrust dynamic bearing portion and a radial dynamic bearing portion in a manner rotatable about a center axis relative to the static portion; wherein
in a state that the rotor portion is lifted to a rated flying height relative to the static portion, the rotor portion is free from coming into contact with the static portion at the thrust dynamic bearing portion when the rotor portion is slanted relative to the static portion until the rotor portion comes into contact with the static portion at a contacting portion in the radial dynamic bearing portion and then is rotated about the contacting portion until the other portion of the rotor portion comes into contact with the static portion.

12. The fluid dynamic bearing device as set forth in claim 11, wherein the rotor portion and the static portion are free from coming into contact with each other when the rotor portion comes into contact with a first axial end portion of the static portion and a second axial end portion of the static portion, and a line connecting first and second axial end portions substantially passes the center axis.

13. The fluid dynamic bearing device as set forth in claim 11, wherein the static portion includes the thrust dynamic bearing surface opposing a portion of the rotor portion and arranged on an axial end surface of the static portion, a clearance of the axial gap defined between the static portion and the rotor portion gradually expands in the thrust dynamic bearing portion in an outer radial direction radially outside of the thrust bearing surface.

14. The fluid dynamic bearing device as set forth in claim 11, wherein the rotor portion or the static portion having a greater hardness has an arithmetical average surface roughness of about 0.02 μm or less at a portion arranged to come into contact with the other of the rotor portion or the static portion.

15. The fluid dynamic bearing device as set forth in claim 14, wherein a clearance of a radial gap defined between the rotor portion and the static portion in the radial dynamic bearing portion is about 1.3 μm to about 2.5 μm.

16. The fluid dynamic bearing device as set forth in claim 11, wherein the rotor portion and the static portion have a Vickers Hardness of about 2000 or greater at surfaces thereof arranged to come into contact with each other.

17. The fluid dynamic bearing device as set forth in claim 11, wherein a hardness of one of the rotor portion or the static portion is a Vickers Hardness of about 100 or greater and is greater than a hardness of the other of the rotor portion or the static portion.

18. The fluid dynamic bearing device as set forth in claim 11, wherein a hardness of one of the rotor portion or the static portion is a Vickers Hardness of about 600 or smaller and is smaller than a hardness of the other of the rotor portion or the static portion.

19. A storage disk drive comprising:
the fluid dynamic bearing device as set forth in claim 11;
a rotor hub supported by the fluid dynamic bearing device in a rotatable manner centered about the center axis;
a data storage disk having about 2.5 inch or less diameter and arranged on the rotor hub;
a base plate on which the fluid dynamic bearing device is arranged;
a driving mechanism which rotates the rotor hub and the data storage disk; and
a head which reads information from the data storage disk and/or writes information onto the data storage disk.

20. A portable electronic device comprising:
the storage disk drive as set forth in claim 19;
an integrated circuit processing information from the data storage disk;
a casing accommodating the data storage disk drive and the integrated circuit.

21. The fluid dynamic bearing device as set forth in claim 11, wherein the rotor portion is a shaft of the fluid dynamic bearing device and the static portion is a sleeve supporting the shaft in a manner rotatable relative to each other.
